(19) United States
(12) Patent Application Publication
(10) Pub. No.: US 2023/0267289 A1
(43) Pub. Date: Aug. 24, 2023

(54) SYSTEMS FOR ALTERNATIVE ILLUMINATION IN GLOBAL SHUTTER BARCODE READERS

(71) Applicant: ZEBRA TECHNOLOGIES CORPORATION, Lincolnshire, IL (US)

(72) Inventors: Christopher W. Brock, Manorville, NY (US); Mark D. Anderson, Dix Hills, NY (US); Robert W. DiGiovanna, Shirley, NY (US)

(21) Appl. No.: 17/679,843

(22) Filed: Feb. 24, 2022

(51) Int. Cl. G06K 7/10

(52) U.S. Cl. CPC G06K 7/10732; G06K 7/10881; G06K 2007/10524

(57) ABSTRACT

Systems for alternative illumination in global shutter barcode readers are disclosed herein. An example system includes an imaging apparatus configured to capture an image during an image capture period, and an imaging shutter configured to actuate and expose the imaging apparatus to an external environment during the image capture period. The example system also includes an illumination light emitting diode (LED) configured to emit illumination, and an illumination drive circuit configured to cause the illumination LED to emit the illumination (i) during the image capture period and (ii) when the imaging apparatus is shielded from exposure to the external environment by the imaging shutter.

### BACKGROUND

Imaging devices, such as barcode readers, generally include shutters that expose an image sensor for a predetermined duration in order to capture images. Typically, these conventional devices only emit illumination during the predetermined duration, and as a result, users of such conventional devices suffer from minimal visibility in low-light environments such that image captures featuring an intended target object are particularly difficult. External illumination sources can alleviate some of these visibility issues, but such external illumination sources can be tedious to handle and carry, especially in addition to the imaging device. As a result, conventional imaging devices suffer from a lack alternative illumination outside of the predetermined duration for image capture.

Accordingly, there is a need for systems for alternative illumination in global shutter barcode readers.

### SUMMARY

In one embodiment, the present invention is an imaging system that includes: an imaging apparatus configured to capture an image during an image capture period; an imaging shutter configured to actuate and expose the imaging apparatus to an external environment during the image capture period; an illumination light emitting diode (LED) configured to emit illumination; and an illumination drive circuit configured to cause the illumination LED to emit the illumination (i) during the image capture period and (ii) when the imaging apparatus is shielded from exposure to the external environment by the imaging shutter.

In a variation of this embodiment, the illumination drive circuit is further configured to cause the illumination LED to emit a first illumination level during the image capture period, and to cause the illumination LED to emit a second illumination level that is different from the first level of illumination when the imaging apparatus is shielded from exposure to the external environment by the imaging shutter.

In another variation of this embodiment, the first illumination level is greater than the second illumination level.

In yet another variation of this embodiment, the illumination drive circuit is further configured to supply the illumination LED with a first driving current level and a second driving current level during the image capture period, the illumination LED emits the first illumination level when the illumination drive circuit supplies the first driving current level, and the illumination LED emits the second illumination level when the illumination drive circuit supplies the second driving current level. Further in this variation, the first driving current level is between 100 mA and 2 A, and the second driving current level is between 70 μA and 1 mA.

In still another variation of this embodiment, the illumination drive circuit comprises: an illumination voltage source configured to provide power to the illumination LED; a high current control configured to control the illumination emitted by the illumination LED during the image capture period; a low current path configured to cause the illumination LED to emit the illumination when the imaging apparatus is shielded from exposure to the external environment by the imaging shutter; and a low current path switch configured to disable current flow through the low current path in a first position and to enable current flow through the low current path in a second position that is different from the first position. Further in this variation, the low current path is at least one of (i) a shunt resistor, (ii) a current sink, or (iii) a field-effect transistor (FET).

In yet another variation of this embodiment, the illumination LED comprises two or more LEDs.

In still another variation of this embodiment, the illumination emitted by the illumination LED is between 0.3 μW and 40 μW.

In yet another variation of this embodiment, the illumination voltage source supplies direct current (DC) power to drive the illumination LED.

In another embodiment, the present invention is an imaging system that includes: an imaging apparatus configured to capture an image during an image capture period; an imaging shutter configured to actuate and expose the imaging apparatus to an external environment during the image capture period; an illumination light emitting diode (LED) configured to emit a first non-zero illumination level and a second non-zero illumination level, wherein the first non-zero illumination level is different from the second non-zero illumination level; and an illumination drive circuit configured to cause the illumination LED to (i) emit the first non-zero illumination level during the image capture period, and to (ii) emit the second non-zero illumination level when the imaging apparatus is shielded from exposure to the external environment by the imaging shutter.

In a variation of this embodiment, the first non-zero illumination level is greater than the second non-zero illumination level.

In another variation of this embodiment, the illumination drive circuit is further configured to supply the illumination LED with a first driving current level and a second driving current level during the image capture period, the illumination LED emits the first non-zero illumination level when the illumination drive circuit supplies the first driving current level, and the illumination LED emits the second non-zero illumination level when the illumination drive circuit supplies the second driving current level. Further in this variation, the first driving current level is between 100 mA and 2 A, and the second driving current level is between 70 μA and 1 mA.

In yet another variation of this embodiment, the illumination drive circuit comprises: an illumination voltage source configured to provide power to the illumination LED; a high current control configured to control the first non-zero illumination level emitted by the illumination LED during the image capture period; a low current path configured to cause the illumination LED to emit the second non-zero illumination level when the imaging apparatus is shielded from exposure to the external environment by the imaging shutter; and a low current path switch configured to disable current flow through the low current path in a first position and to enable current flow through the low current path in a second position that is different from the first position. Further in this variation, the low current path is at least one of (i) a shunt resistor, (ii) a current sink, or (iii) a field-effect transistor (FET).

In still another variation of this embodiment, the illumination LED comprises two or more LEDs.

In yet another variation of this embodiment, the first non-zero illumination level emitted by the illumination LED is between 0.3 μW and 40 μW, and the second non-zero illumination level emitted by the illumination LED is between 0.3 μW and 40 μW.

In still another variation of this embodiment, the illumination voltage source supplies direct current (DC) power to drive the illumination LED.

In yet another embodiment, the present invention is a method comprising: emitting, by an illumination light emitting diode (LED), illumination at a first non-zero illumination level in response to a user pulling a trigger configured to initiate an image capture period wherein an imaging shutter actuates and exposes an imaging apparatus to an external environment; periodically oscillating, by an illumination drive circuit, the emitted illumination between the first non-zero illumination level and a second non-zero illumination level during the image capture period; and emitting, by the illumination LED, the second non-zero illumination level after the image capture period when the imaging apparatus is shielded from the external environment by the imaging shutter.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of an example scanning device, in accordance with various embodiments of the present invention.

FIG. 2 is a block diagram representative of an example logic circuit for implementing the example scanning device of FIG. 1, in accordance with embodiments described herein.

FIG. 3 illustrates an example illumination drive circuit configured to drive an illumination light-emitting diode (LED), in accordance with various embodiments of the present invention.

FIG. 4A illustrates an example prior art current pulse train pattern.

FIG. 4B illustrates an example current pulse train pattern generated by the illumination drive circuit of FIG. 3 in order to drive the illumination LED while the imaging apparatus is exposed to an external environment, in accordance with various embodiments of the present invention.

FIG. 5 illustrates an example method for providing alternative illumination for an illumination LED, in accordance with various embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Imaging device, such as a barcode scanner, users often desire to capture images in low-light environments. However, conventional imaging devices lack illumination sources outside of an integrated source that emits illumination only when the imaging device captures an image. Many conventional imaging device users are thus unable to determine the location/position of a target object in low-light environments prior to triggering the imaging device to capture an image. As a result, users of these conventional imaging devices are forced to capture multiple images without any confidence that the target object is appropriately positioned within the imaging device field of view (FOV), yielding unusable and/or otherwise sub-optimal images.

The systems/methods of the present disclosure provide solutions to this illumination problem associated with traditional imaging devices. Namely, the methods/systems of the present disclosure alleviate these illumination problems associated with traditional imaging devices by introducing a low current path from the illumination voltage source that causes the illumination LED to emit an alternative (also referenced herein as a “constant”) illumination level that provides constant, low-level illumination for users. The constant illumination level may be optionally switched on/off, as needed, thereby enabling a user to see in low-light environments prior to image capture without requiring an external illumination source. In this manner, users may see target objects within the FOV prior to image capture, ensuring that subsequent image captures feature the target object; and more generally, users may see the surrounding external environment without requiring an additional illumination source (e.g., a flashlight).

Additionally, in certain low-light environments such as a hospital, low illumination levels may be desirable to, for example, avoid waking sleeping patients and/or otherwise causing undue stress to patients. In these environments, the constant illumination level may enable a nurse or other practitioner to enter a patient's room at night and capture images of surgical locations, wound sites, and/or otherwise perform necessary procedures without disturbing the patient.

Moreover, such a constant illumination level enables the user to determine when the batteries of a battery-powered imaging device require charging. In particular, when a battery-powered imaging device stops emitting the constant illumination level, a user may quickly and readily understand that the imaging device batteries require charging. Similarly, for a corded imaging device, the user may quickly and readily understand when a charging cable is successfully attached and charging the corded imaging device when the corded imaging device begins emitting the constant illumination level.

As a result, the systems/methods of the present disclosure maximize device efficiency by enabling users to more efficiently use the imaging devices in low-light environments, and by informing users when the imaging devices require charging. Further, the systems/methods of the present disclosure greatly improve the user experience and increase user safety by enabling users to see external environments without requiring additional equipment beyond the imaging device.

As referenced herein, the illumination source(s) included as part of the exemplary imaging device(s) are light-emitting diodes (LEDs) configured to output light within visible wavelength ranges. However, it should be appreciated that the systems described herein may utilize illumination sources of any suitable type, color, design and/or combinations thereof.

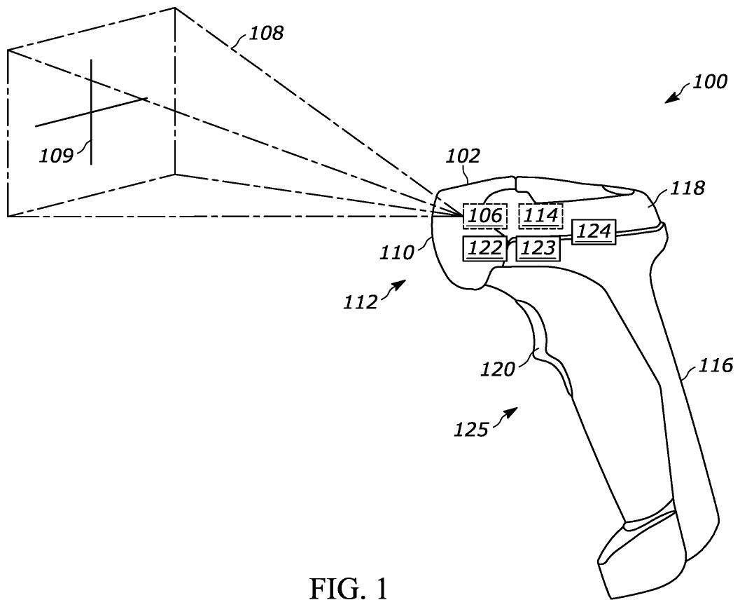

Referring now to the drawings, FIG. 1 is a perspective view of an example imaging device 100, in accordance with various embodiments of the present invention. The example imaging device 100 includes an example housing 102 that includes a generally elongated handle or lower handgrip portion 116, and an upper body portion 118 having the front side 112 at which the front-facing opening or window 110 is located. The cross-sectional dimensions and overall size of the handgrip portion 116 are such that the example imaging device 100 can be conveniently held in an operator's hand during operation. The front-facing opening or window 110 is configured to face generally away from a user when the user has the example imaging device 100 in a handheld position. The portions 116 and 118 may be constructed of a lightweight, resilient, shock-resistant, self-supporting material, such as a synthetic plastic material. The housing 102 may be injection molded, but can also be vacuum-formed or blow-molded to form a thin hollow shell which bounds an interior space whose volume is sufficient to contain the various components of the handheld scanner 100. Although the housing 102 is illustrated as a portable, point-of-transaction, gun-shaped, handheld housing, any other configuration including a hands-free configuration could be used.

The example imaging device 100 also includes an imaging apparatus 106 that is disposed within the example housing 102. The imaging apparatus 106 captures image data representing a target in a field of view 108 at least partially defined by a front-facing opening or window 110 (also referenced herein as an “optical window”) on a front side 112 of the example imaging device 100. The example imaging device 100 also includes an imaging shutter 122 configured to actuate and expose the imaging apparatus 106 to an external environment, a portion of which is included in the FOV 108.

More specifically, the example imaging device 100 may also include a manually actuatable trigger 120 that is mounted in a moving relationship on the handgrip portion 116 in a forward facing region 124 of the handgrip portion 116 that is configured to actuate the imaging shutter 122. An operator's finger can be used to actuate (e.g., depress) the trigger 120 once a target falls within the imaging field of view 108, thereby causing the imaging shutter 122 to actuate (e.g., open) and expose the imaging apparatus 106 to capture an image of the target. As a result of actuating the trigger 120, the example imaging device 100 may generate an aiming pattern 109, which may visually indicate the field of view 108 of the example imaging device 100 for the operator utilizing the device 100, and may more specifically indicate a region within the field of view 108 where the device 100 may successfully scan and/or otherwise interpret an indicia within the field of view 108. In certain instances, the imaging apparatus 106 may be configured to capture the image during an image capture period, during which, the imaging shutter 122 actuates and exposes the imaging apparatus 106 to the external environment. The example imaging device 100 also includes an indicia decoder 114 in communication with the imaging apparatus 106, and configured to receive image data comprising the image and decode an indicia represented in the image data.

The example imaging device 100 also includes an illumination light emitting diode (LED) 123 configured to emit illumination, and an illumination drive circuit 124 configured to cause the illumination LED 123 to emit illumination. Generally speaking, the illumination LED 123 may be configured to output illumination in response to receiving a forward voltage from the illumination drive circuit 124 as a result of the operator actuating the trigger 120. In particular, the illumination drive circuit 124 may be configured to cause the illumination LED 123 to emit illumination (i) when the imaging shutter 122 actuates and exposes the imaging apparatus 106 to the external environment, and (ii) when the imaging apparatus 106 is shielded from exposure to the external environment by the imaging shutter 122.

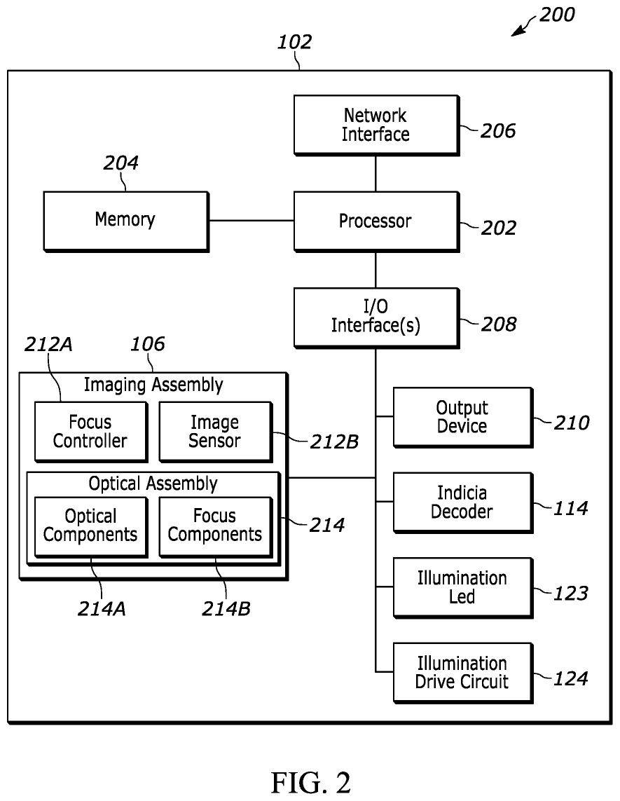

FIG. 2 is a block diagram representative of an example logic circuit capable of implementing, for example, the example imaging device 100 of FIG. 1. The example logic circuit of FIG. 2 is a processing platform 200 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 200 of FIG. 2 includes a processor 202 such as, for example, one or more microprocessors, controllers, and/or any suitable type of processor. The example processing platform 200 of FIG. 2 includes memory (e.g., volatile memory, non-volatile memory) 204 accessible by the processor 202 (e.g., via a memory controller). The example processor 202 interacts with the memory 204 to obtain, for example, machine-readable instructions stored in the memory 204 corresponding to, for example, the operations represented by the flowchart(s) of this disclosure. Additionally, or alternatively, machine-readable instructions corresponding to the example operations described herein may be stored on one or more removable media (e.g., a compact disc (CD), a digital versatile disc (DVD), removable flash memory, etc.) that may be coupled to the processing platform 200 to provide access to the machine-readable instructions stored thereon. The processor 202 and the memory 204 are disposed in the housing 102.

The example processing platform 200 of FIG. 2 includes one or more communication interfaces such as, for example, one or more network interfaces 206, and/or one or more input/output (I/O) interfaces 208 disposed in the housing 102. The communication interface(s) may enable the processing platform 200 of FIG. 2 to communicate with, for example, another device, system, host system (e.g., an inventory management system, a POS station, etc.), datastore, database, and/or any other machine.

The example processing platform 200 of FIG. 2 may include the network interface(s) 206 to enable communication with other machines (e.g., an inventory management system, a POS station, etc.) via, for example, one or more networks. The example network interface(s) 206 include any suitable type of communication interface(s) (e.g., wired and/or wireless interfaces) configured to operate in accordance with any suitable communication protocol(s). Example network interfaces 206 include a TCP/IP interface, a Wi-Fi™ transceiver (e.g., according to the IEEE 802.11x family of standards), an Ethernet transceiver, a cellular network radio, a satellite network radio, or any other suitable interface based on any other suitable communication protocols or standards.

The example, processing platform 200 of FIG. 2 may include the input/output (I/O) interface(s) 208 (e.g., a Bluetooth® interface, a near-field communication (NFC) interface, a universal serial bus (USB) interface, a serial interface, an infrared interface, etc.) to (1) enable receipt of user input (e.g., from the trigger 120 of FIG. 1, a touch screen, keyboard, mouse, touch pad, joystick, trackball, microphone, button, etc.), (2) communicate output data (e.g., mode change confirmations, visual indicators, instructions, data, images, etc.) to the user (e.g., via an output device 210, speaker, printer, haptic device, etc.), and/or (3) interact with other components of the handheld scanner 200 (e.g., the imaging assembly 106, the output device 210, the indicia decoder 114, the illumination LED 123, the illumination drive circuit 124, etc.). Example output devices 210 may include a sound generation device, a haptic device, or the like.

To capture images of objects and/or barcodes on objects, the example processing platform 200 includes the imaging assembly 106 disposed in the housing. The imaging assembly 106 includes an image sensor 2126 under control of, for example, the processor 202 to capture image frames representative of the portion of an environment in which the example imaging device 100 is operating that falls within the imaging field of view 108 of the imaging assembly 106. The image sensor 2126 includes a plurality of photosensitive elements forming a substantially flat surface. The processor 202 may be communicatively coupled to the imaging assembly 106 via the input/output (I/O) interface(s) 208.

The imaging assembly 106 includes an optical assembly 214 to form images of objects in the field of view 108 on the surface of the image sensor 2126. The optical assembly 214 may include any number and/or type(s) of optical elements and/or components 214A including, for example, one or more lenses, filters, focus motors, apertures, lens holder, liquid lenses, or any other components and/or optical elements. Moreover, to focus the imaging assembly 106 on an object, the imaging assembly 106 may include a focus controller 212A, and the optical assembly 214 may include any number and/or type(s) of focus components 214B (e.g., motors, liquid lenses, etc.). In some examples, the focus controller 212A is implemented by the processor 202. In some examples, the imaging assembly 106 is a fixed-focus scanner.

The example processing platform 200 also includes any number and/or type(s) indicia decoders 114 (e.g., the indicia decoder 114) to detect and/or decode indicia to determine the payload of the indicia. In some examples, the indicia decoder 114 is implemented by the processor 202. The indicia decoder 114, e.g., via the processor 202, conveys the payload of decoded indicia to a host system via a communication interface such as the network interface(s) 206 and/or the I/O interface(s) 208.

To illuminate a target to be imaged, the example processing platform 200 may also include the illumination LED 123. The illumination LED 123 may emit illumination in the field of view 108 to, for example, facilitate autofocusing and/or improve the quality of image frames captured by the image sensor 106. The example processing platform 200 may also include an illumination drive circuit 124 that is configured to supply a driving voltage to the illumination LED 123 to cause the LED 123 to emit the illumination (i) when the imaging shutter (e.g., imaging shutter 122) actuates and exposes the imaging apparatus 106 to the external environment and (ii) when the imaging apparatus 106 is shielded from exposure to the external environment by the imaging shutter 122. More generally, the illumination drive circuit 124 may provide constant driving current to the illumination LED 123 in order to cause the illumination LED 123 to output constant illumination regardless of whether or not the imaging assembly 106 captures an image. In particular, when the imaging assembly captures an image, the illumination drive circuit 124 may drive a first level of current through the illumination LED 123 in order to provide sufficient illumination for an image capture, and when the imaging assembly is not capturing an image, the illumination drive circuit 124 may drive a second level of current through the illumination LED 123 in order to provide sufficient illumination, for example, for an operator to see in low-light conditions.

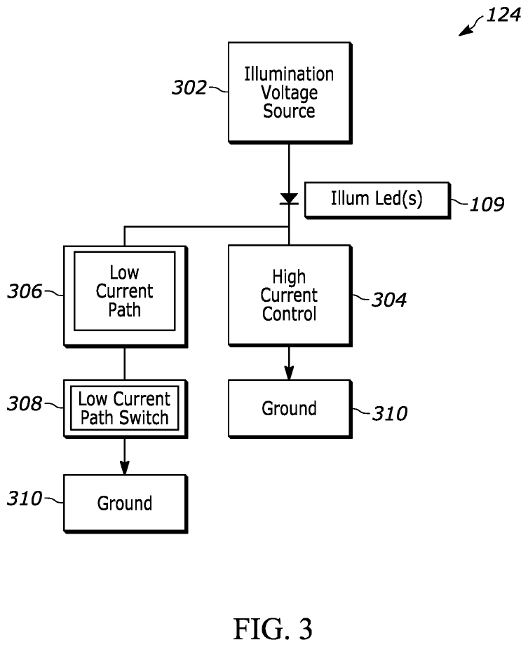

FIG. 3 illustrates an example illumination drive circuit 124 configured to drive an illumination light-emitting diode (LED) 109, in accordance with various embodiments of the present invention. Generally, the illumination drive circuit 124 may supply voltage/current output to drive the illumination LED 109 in order to provide illumination during image capture, and constant, lower-level illumination when not capturing an image. As mentioned, the illumination LED 109 illustrated in FIG. 3 may be and/or include a single LED, multiple LEDs configured in series, multiple LEDs configured in parallel, multiple LEDs configured in series/parallel, and/or any other suitable number and/or configuration of LEDs or illumination sources or combinations thereof.

As illustrated in FIG. 3, the illumination drive circuit 124 may include an illumination voltage source 302 that supplies power to cause the Illumination LED 109 to emit illumination (i) when the imaging shutter (e.g., imaging shutter 122) actuates and exposes the imaging apparatus (e.g., imaging apparatus 106) to the external environment and (ii) when the imaging apparatus 106 is shielded from exposure to the external environment by the imaging shutter 122. In particular, the illumination voltage source 302 may provide direct current (DC) power to drive the illumination LED 109 to emit the illumination, and the DC power may be of any amplitude that is sufficient to overcome voltage headroom issues that may be present as part of the example imaging device 100. However, in certain aspects, the illumination voltage source 302 may provide indirect current (IC) power in order to drive the illumination LED 109 to emit the illumination.

The illumination drive circuit 124 also includes a high current control 304 that generally controls the current level and the current duration that are utilized to drive the illumination LED 109 to emit current pulses during image capture. More generally, the illumination LED 109 may emit illumination pulses during an image capture that each have a consistent amplitude and duration, as governed by the current level and the current duration supplied as a result of the high current control 304. In certain aspects, the high current control 304 may control the current used to drive the illumination LED 109 between 100 milliamps (mA) and 2 amps (A), such that the current flowing through the illumination LED 109 when the LED 109 is emitting illumination during an image capture period may be between approximately 100 mA and/or up to approximately 2 A. The high current control 304 may drive the illumination LED 109 to emit a first illumination level that is relatively higher than a second illumination level (e.g., between 0.3 μW and 40 μW) emitted by the illumination LED 109 when the current flows through the low current path 306.

When the illumination LED 109 is not emitting illumination as part of an image capture, the illumination LED 109 still emits illumination utilizing current flowing through the low current path 306. Generally, the low current path 306 may control a relatively lower current level through the illumination LED 109 than the high current control 304 in order to output the second illumination level that is lower than the first illumination level output by the illumination LED 109 during an image capture. For example, the low current path 306 may cause the current flowing through the illumination LED 109 when the imaging shutter (e.g., imaging shutter 122) is closed, and by extension, the imaging apparatus (e.g., the image sensor 2126) is not exposed to the external environment to be between 70 microamps (μA) and 1 mA, such that the illumination LED 109 emits the second illumination level (e.g., between 0.3 μW and 40 μW). The low current path 306 may be any suitable component, such as (i) a shunt resistor, (ii) a current sink, (iii) a field-effect transistor (FET), and/or any other suitable component or combinations thereof.

It should be understood that the illumination levels and current values provided herein are for the purposes of discussion only. The illumination levels output by the illumination LED 109 as a result of control from the high current control 304 and/or the low current path 306 may be any suitable values and may correspond to any suitable distance(s) from the illumination LED 109 and any suitable resistance values corresponding to the high current control 304 and/or the low current path 306. Similarly, the current values flowing through the illumination LED 109 may be any suitable values, based on the voltage supplied by the illumination voltage source 302, the resistance values of the high current control 304 and/or the low current path 306, and which particular type of LED and/or other illumination source is included as part of the illumination LED 109.

For example, the illumination levels provided herein may be approximate values corresponding to an illumination level achieved by the illumination LED 109 anywhere from 0 to 5 inches away from the illumination LED 109. In this example, the illumination LED 109 may achieve approximately 0.3 μW of illumination at 4 inches away from the illumination LED 109 when the low current path 306 includes a 26 kiloohm (kΩ) resistor and 100 μA of current are flowing through the illumination LED 109. As another example, the illumination LED 109 may achieve approximately 39 μW of illumination at 1 inch away from the illumination LED 109 when the high current control 304 includes a 3.3 kΩ resistor and 800 μA of current are flowing through the illumination LED 109. Regardless, it should be understood that the illumination provided by the illumination LED 109 may be of any suitable level (e.g., measured in Watts, footcandles, etc.), based on the voltage supplied by the illumination voltage source 302, resistance values included as part of the high current control 304 and/or the low current path 306, the current flowing through the illumination LED 109, and the distance from the illumination LED 109 to the target.

In any event, the low current path 306 may create a current path through the illumination LED 109 that is always on and driving the illumination LED 109, provided that the illumination voltage source 302 is present. However, in certain instances, a user may desire that the imaging device (e.g., example imaging device 100) does not emit constant illumination, and may utilize the low current path switch 308 to disable the current flow through the low current path 306 and correspondingly stop the illumination LED 109 from emitting illumination at the second illumination level. The low current path switch 308 may thus enable a user to more appropriately utilize the imaging device in circumstances where constant illumination is not necessary, such as meeting a universal serial bus (USB) suspend, preserving battery life by minimizing the overall current draw on the battery, etc. Of course, it should again be noted that such constant illumination may provide a user with a convenient indication of low battery life, such that when the constant illumination is enabled but not emitted by the illumination LED 109, a user may recognize that the batteries and/or the device may require re-charging.

The illumination drive circuit 124 may generally also include other electronic component(s) that are electrically coupled to the illumination drive circuit 124. For example, the illumination drive circuit 124 may include additional illumination LEDs, one or more voltage sources, additional current paths, and/or any other suitable electronic component or combinations thereof. As illustrated in FIG. 3, the high current control 304 and the low current path switch 308 may also be electrically coupled to a ground 310, such that the illumination LED 109 receives input drive voltage from the illumination voltage source 302 which is discharged to the ground 310 regardless of whether the current flows through the high current control 304 or the low current path 306 and low current path switch 308.

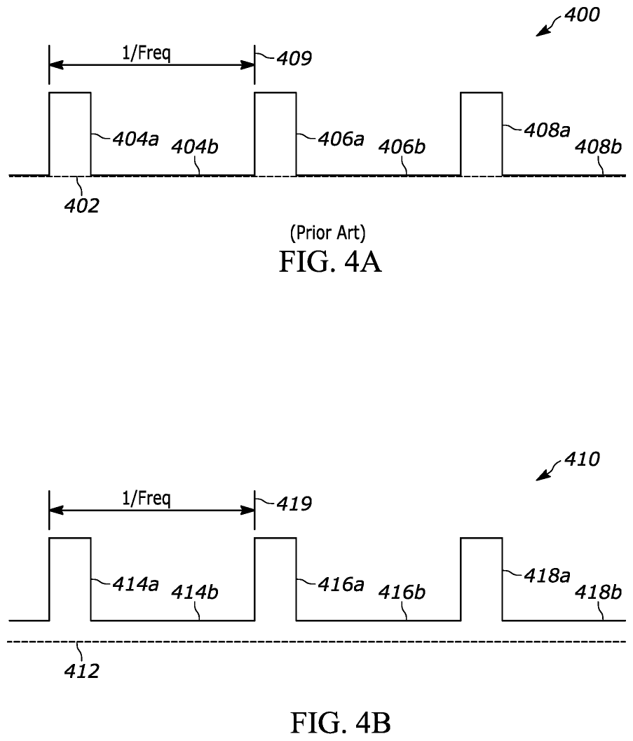

FIG. 4A illustrates an example prior art current pulse train pattern 400. The prior art current pulse train pattern 400 generally includes a series of high current pulses offset by zero current troughs oscillating quickly enough to be virtually indistinguishable to the human eye. In this manner, the illumination source may emit sufficient illumination for an image capture without constantly emitting illumination. In particular, as illustrated in FIG. 4A, the prior art current pulse train pattern 400 includes a zero-current level 402, a first current pulse 404a, a first current trough 404b, a second current pulse 406a, a second current trough 406b, a third current pulse 408a, a third current trough 408b, and a current pulse period 409. During a current pulse train similar to the pattern 400 illustrated in FIG. 4A, the input current may rapidly jump from the zero-current level 402 to a peak current level, and may remain at the peak current level for a brief period before rapidly dropping back to the zero-current level 402, thereby defining each of the current pulses 404a, 406a, 408a. After dropping back to the zero-current level 402, the current may remain at the zero-current level 402 for a longer duration than when the current remained at the peak current level before jumping back to the peak current level as part of a subsequent current pulse, thereby defining each of the current troughs 404b, 406b, 408b.

This oscillation between the peak current level at each of the current pulses 404a, 406a, 408a, and the zero-current level 402 at each of the current troughs 404b, 406b, 408b occurs in accordance with the current pulse period 409, which may be defined as the inverse frequency of the oscillations. However, as mentioned, the oscillations of this prior art current pulse train pattern 400 occur between a peak, non-zero driving current level and a zero-current level 402. Thus, during each of the current pulses 404a, 406a, 408a, the illumination source emits a pre-defined level of illumination, but during each of the current troughs 404b, 406b, 408b, the illumination source does not emit any illumination.

By contrast, FIG. 4B illustrates an example current pulse train pattern 410 generated by the illumination drive circuit 124 of FIG. 3 in order to constantly drive the illumination LED (e.g., illumination LED 109) while the imaging apparatus (e.g., imaging apparatus 106) is exposed to an external environment, in accordance with various embodiments of the present invention. The current pulse train pattern 410 generally includes a series of high current pulses offset by non-zero driving current troughs oscillating quickly enough to be virtually indistinguishable to the human eye. In this manner, the illumination LED 109 may emit sufficient illumination for an image capture during the high current pulses and may constantly emit a lower level illumination during the non-zero driving current troughs.

In particular, as illustrated in FIG. 4B, the current pulse train pattern 410 includes a zero-current level 412, a first current pulse 414a, a first current trough 414b, a second current pulse 416a, a second current trough 416b, a third current pulse 418a, a third current trough 418b, and a current pulse period 419. During a current pulse train similar to the pattern 410 illustrated in FIG. 4B, the input current may rapidly jump from the non-zero driving current level represented by each of the current troughs 414b, 416b, 418b to a peak current level, and may remain at the peak current level for a brief period before rapidly dropping back to the non-zero driving current level, thereby defining each of the current pulses 414a, 416a, 418a. After dropping back to the non-zero driving current level, the current may remain at the non-zero driving current level for a longer duration than when the current remained at the peak current level before jumping back to the peak current level as part of a subsequent current pulse, thereby defining each of the current troughs 414b, 416b, 418b.

This oscillation between the peak current level at each of the current pulses 414a, 416a, 418a, and the non-zero driving current level at each of the current troughs 414b, 416b, 418b occurs in accordance with the current pulse period 419, which may be defined as the inverse frequency of the oscillations. As mentioned, the oscillations of this current pulse train pattern 410 occur between a peak, non-zero driving current level for each of the current pulses 414a, 416a, 418a and a non-zero driving current level for each of the current troughs 414b, 416b, 418b. Thus, during each of the current pulses 414a, 416a, 418a, the illumination LED 109 emits a pre-defined level of illumination, and during each of the current troughs 414b, 416b, 418b, the illumination LED 109 emits a relatively smaller, non-zero level of illumination.

It should be understood that the current pulse train pattern 410 illustrated in FIG. 4B is for the purposes of illustration/discussion only. For example, the gap between the zero current level 412 and the current level of each current trough 414b, 416b, 418b may be visually exaggerated (e.g., larger than normal, smaller than normal) relative to the current level of the current pulses 414a, 416a, 418a to highlight that the current troughs 414b, 416b, 418b correspond to a non-zero driving current level, and therefore correspond to a non-zero level of illumination emitted by the illumination LED 109. Moreover, the duration of the current pulses 414a, 416a, 418a relative to the current troughs 414b, 416b, 418b may be visually exaggerated (e.g., larger than normal, smaller than normal) to clearly illustrate the differences between current levels. Of course, the actual parameters (e.g., period, amplitude) of the current pulses 414a, 416a, 418a and/or the current troughs 414b, 416b, 418b may be any suitable values.

As another example, in certain instances, the current levels illustrated in FIG. 4B may not remain constant during the image capture period. Namely, while the illumination drive circuit 124 provides a first current level to drive the illumination LED 123 to emit illumination for image capture, the current level of the current pulses 414a, 416a, 418a may slope from a maximum current level (e.g., the peaks of the current pulses 414a, 416a, 418a) to a smaller current level that is less than the maximum current level but greater than the current level of the current troughs 414b, 416b, 418b. This sloping of the current level of the current pulses 414a, 416a, 418a may result in the current pulses 414a, 416a, 418a having a rounded appearance as the current level decreases from the initial maximum current level, and may occur, for example, in instances where the illumination voltage source 302 is a storage capacitor from which charge is pulled. However, in instances where the illumination voltage source 302 is a power supply of higher capacity than a storage capacitor (e.g., the battery of a terminal), the slope or roll off from the maximum current value may be virtually unnoticeable.

Moreover, the current pulse train pattern 410 of FIG. 4B may generally correspond to an image capture period during which the imaging apparatus (e.g., imaging apparatus 106) is exposed to the portion of the external environment defined by the FOV (e.g., FOV 108) of the imaging device (e.g., example imaging device 100) by an imaging shutter (e.g., imaging shutter 122) that operates as a global shutter, such that all pixels of the image sensor (e.g. image sensor 212B) are simultaneously exposed to the portion of the external environment defined by the FOV 108 of the imaging device 100. However, in certain aspects, the current pulse train pattern 410 may correspond to an image capture period during which the imaging apparatus 106 is exposed to the portion of the external environment defined by the FOV 108 of the imaging device 100 by an imaging shutter 122 that operates as a rolling shutter, such that adjacent rows/portions of the pixel layout of the image sensor 212B are exposed to the portion of the external environment defined by the FOV 108 of the imaging device 100 at slightly different times during the image capture period.

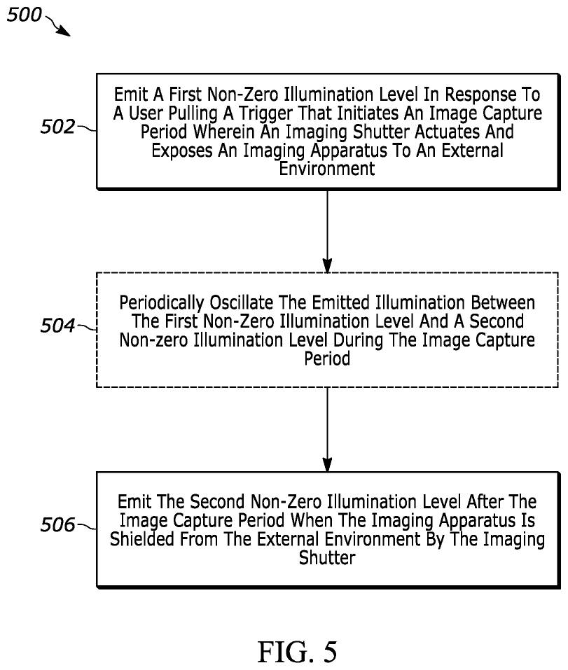

FIG. 5 illustrates an example method 500 for providing alternative illumination for an illumination LED, in accordance with various embodiments of the present invention. It should be understood that, in certain embodiments, any of the blocks of the method 500 may be performed by any of the example imaging device 100, the imaging assembly 106, the illumination LED 123, the illumination drive circuit 124, the processor(s) 202, and/or any other suitable device.

The method 500 includes providing a first non-zero illumination level in response to a user pulling a trigger configured to actuate an imaging shutter and expose an imaging apparatus to an external environment (block 502). Generally, the user pulling the trigger (e.g., trigger 120) may initiate an image capture period, during which the imaging shutter (e.g., imaging shutter 122) actuates and exposes the imaging apparatus (e.g., imaging apparatus 106) to the external environment within the POV 108. In certain instances, the imaging device 100 may automatically perform an image capture sequence during the image capture period, and when the image capture sequence finishes, the image capture period may also end regardless of whether or not the user releases the trigger 120. For example, when the user pulls the trigger 120, the imaging shutter 122 may actuate and expose the imaging apparatus 106, which may proceed to capture an image(s) of the environment represented in the POV 108. Once the imaging apparatus 106 has captured the image(s) of the environment represented in the POV 108, the imaging shutter 122 may automatically close to shield the imaging apparatus 106 from the external environment, thereby concluding the image capture sequence and the image capture period. The user may continue to hold the trigger 120, and the imaging device 100 may eventually notify the user that the image capture has been successful and/or otherwise has concluded.

In any event, during the image capture period, the illumination LED (e.g., illumination LED 109) may emit a first non-zero illumination level in order to capture an image. The illumination drive circuit (e.g., illumination drive circuit 124) may provide the illumination LED 109 with sufficient current to output the first non-zero illumination level by utilizing, for example, the high current control 304 of FIG. 3. Further, in certain aspects, the first non-zero illumination level may be any suitable level of illumination, such as between approximately 0.3 μW and 40 μW.

The method 500 may optionally include periodically oscillating the emitted illumination between the first non-zero illumination level and a second non-zero illumination level while the user pulls the trigger 120 (optional block 504). For example, as illustrated in FIG. 4B, the current pulse train pattern 410 periodically oscillates between the relatively higher first non-zero driving current level of the current pulses 414a, 416a, 418a and the relatively lower second non-zero driving current level of the current troughs 414b, 416b, 418b based on the current pulse period 419. The first non-zero driving current level and the second non-zero driving current level correspond to different, non-zero levels of illumination emitted by the illumination LED 109, and the first non-zero driving current level may cause the illumination LED 109 to emit a first non-zero illumination level and the second non-zero driving current level may cause the illumination LED 109 to emit a second non-zero illumination level. Thus, in certain aspects, the first illumination level is greater than the second illumination level, and the first driving current level may be between 100 mA and 2 A, and the second driving current level may be between 70 μA and 1 mA.

The method 500 may also include emitting the second non-zero illumination level after the user releases the trigger 120 and the imaging apparatus 106 is shielded from the external environment by the imaging shutter 122 (block 506). In certain aspects, the illumination drive circuit 124 is further configured to cause the illumination LED 109 to emit a first illumination level during the image capture period, and to cause the illumination LED 109 to emit a second illumination level that is different from the first level of illumination when the imaging apparatus is shielded from exposure to the external environment by the imaging shutter 122. As a result, the illumination drive circuit 124 may be further configured to supply the illumination LED 109 with a first driving current level and a second driving current level during the image capture period, such that the illumination LED 109 emits the first illumination level when the illumination drive circuit 124 supplies the first driving current level and the illumination LED 109 emits the second illumination level when the illumination drive circuit 124 supplies the second driving current level.

In some aspects, the illumination drive circuit 124 may comprise an illumination voltage source (e.g., illumination voltage source 302) configured to provide power to the illumination LED 109. Moreover, the illumination drive circuit 124 may include a high current control (e.g., high current control 304) configured to control the illumination emitted by the illumination LED 109 during the image capture period. Further, the illumination drive circuit 124 may include a low current path (e.g., low current path 306) configured to cause the illumination LED 109 to emit the illumination when the imaging apparatus 106 is shielded from exposure to the external environment by the imaging shutter 122, and a low current path switch (e.g., low current path switch 308) configured to disable current flow through the low current path 306 in a first position and to enable current flow through the low current path 306 in a second position that is different from the first position. As an example, a user may position the low current path switch 308 in the first position in order to enable the imaging device 100 to emit constant illumination based on the second non-zero driving current level flowing through the illumination LED 109 and the low current path 306. However, if the user desires the imaging device 100 to not provide such constant illumination, the user may place the low current path switch 308 in the second position in order to disable the flow of the second non-zero driving current through the illumination LED 109 and the low current path 306. As a result, when the user places the low current path switch 308 into the second position, the imaging device 100 may not provide any illumination when not capturing an image.

In certain aspects, the low current path is at least one of (i) a shunt resistor, (ii) a current sink, or (iii) a field-effect transistor (FET). Moreover, in some aspects, the illumination LED may comprise two or more LEDs, the first non-zero illumination level emitted by the illumination LED may be between 0.3 μW and 40 μW, and the second non-zero illumination level emitted by the illumination LED may be between 0.3 μW and 40 μW. Further, in certain aspects, the illumination voltage source 302 may supply direct current (DC) power to drive the illumination LED 109.

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An imaging system comprising:
an imaging apparatus configured to capture an image during an image capture period;
an imaging shutter configured to actuate and expose the imaging apparatus to an external environment during the image capture period;
an illumination light emitting diode (LED) configured to emit illumination; and
an illumination drive circuit configured to cause the illumination LED to emit the illumination (i) during the image capture period and (ii) when the imaging apparatus is shielded from exposure to the external environment by the imaging shutter.

2. The imaging system of claim 1, wherein the illumination drive circuit is further configured to cause the illumination LED to emit a first illumination level during the image capture period, and to cause the illumination LED to emit a second illumination level that is different from the first level of illumination when the imaging apparatus is shielded from exposure to the external environment by the imaging shutter.

3. The imaging system of claim 2, wherein the first illumination level is greater than the second illumination level.

4. The imaging system of claim 2, wherein the illumination drive circuit is further configured to supply the illumination LED with a first driving current level and a second driving current level during the image capture period, the illumination LED emits the first illumination level when the illumination drive circuit supplies the first driving current level, and the illumination LED emits the second illumination level when the illumination drive circuit supplies the second driving current level.

5. The imaging system of claim 4, wherein the first driving current level is between 100 mA and 2 A, and the second driving current level is between 70 μA and 1 mA.

6. The imaging system of claim 1, wherein the illumination drive circuit comprises:
an illumination voltage source configured to provide power to the illumination LED;
a high current control configured to control the illumination emitted by the illumination LED during the image capture period;
a low current path configured to cause the illumination LED to emit the illumination when the imaging apparatus is shielded from exposure to the external environment by the imaging shutter; and
a low current path switch configured to disable current flow through the low current path in a first position and to enable current flow through the low current path in a second position that is different from the first position.

7. The imaging system of claim 8, wherein the low current path is at least one of (i) a shunt resistor, (ii) a current sink, or (iii) a field-effect transistor (FET).

8. The imaging system of claim 1, wherein the illumination LED comprises two or more LEDs.

9. The imaging system of claim 1, wherein the illumination emitted by the illumination LED is between 0.3 μW and 40 μW.

10. The imaging system of claim 1, wherein the illumination voltage source supplies direct current (DC) power to drive the illumination LED.

11. An imaging system comprising:
an imaging apparatus configured to capture an image during an image capture period;
an imaging shutter configured to actuate and expose the imaging apparatus to an external environment during the image capture period;
an illumination light emitting diode (LED) configured to emit a first non-zero illumination level and a second non-zero illumination level, wherein the first non-zero illumination level is different from the second non-zero illumination level; and
an illumination drive circuit configured to cause the illumination LED to (i) emit the first non-zero illumination level during the image capture period, and to (ii) emit the second non-zero illumination level when the imaging apparatus is shielded from exposure to the external environment by the imaging shutter.

12. The imaging system of claim 11, wherein the first non-zero illumination level is greater than the second non-zero illumination level.

13. The imaging system of claim 11, wherein the illumination drive circuit is further configured to supply the illumination LED with a first driving current level and a second driving current level during the image capture period, the illumination LED emits the first non-zero illumination level when the illumination drive circuit supplies the first driving current level, and the illumination LED emits the second non-zero illumination level when the illumination drive circuit supplies the second driving current level.

14. The imaging system of claim 13, wherein the first driving current level is between 100 mA and 2 A, and the second driving current level is between 70 μA and 1 mA.

15. The imaging system of claim 11, wherein the illumination drive circuit comprises:
an illumination voltage source configured to provide power to the illumination LED;
a high current control configured to control the first non-zero illumination level emitted by the illumination LED during the image capture period;
a low current path configured to cause the illumination LED to emit the second non-zero illumination level when the imaging apparatus is shielded from exposure to the external environment by the imaging shutter; and
a low current path switch configured to disable current flow through the low current path in a first position and to enable current flow through the low current path in a second position that is different from the first position.

16. The imaging system of claim 15, wherein the low current path is at least one of (i) a shunt resistor, (ii) a current sink, or (iii) a field-effect transistor (FET).

17. The imaging system of claim 11, wherein the illumination LED comprises two or more LEDs.

18. The imaging system of claim 11, wherein the first non-zero illumination level emitted by the illumination LED is between 0.3 μW and 40 μW, and the second non-zero illumination level emitted by the illumination LED is between 0.3 μW and 40 μW.

19. The imaging system of claim 11, wherein the illumination voltage source supplies direct current (DC) power to drive the illumination LED.

20. A method comprising:
emitting, by an illumination light emitting diode (LED), illumination at a first non-zero illumination level in response to a user pulling a trigger configured to initiate an image capture period wherein an imaging shutter actuates and exposes an imaging apparatus to an external environment;
periodically oscillating, by an illumination drive circuit, the emitted illumination between the first non-zero illumination level and a second non-zero illumination level during the image capture period; and
emitting, by the illumination LED, the second non-zero illumination level after the image capture period when the imaging apparatus is shielded from the external environment by the imaging shutter.
